(19) United States
(12) Patent Application Publication
(10) Pub. No.: US 2026/0175727 A1
(43) Pub. Date: Jun. 25, 2026

(54) CHARGING AND DISCHARGING BATTERY SYSTEM FOR E-CARS

(71) Applicant: Roger Ward, Euclid, OH (US)

(72) Inventor: Roger Ward, Euclid, OH (US)

(21) Appl. No.: 19/542,763

(22) Filed: Feb. 18, 2026

Related U.S. Application Data
(63) Continuation-in-part of application No. 18/887,062, filed on Sep. 17, 2024.
(60) Provisional application No. 63/634,064, filed on Apr. 15, 2024.

(51) Int. Cl. B60L 53/57; B60L 53/51; B60L 58/18; H02J 7/00; H02J 7/14; H02K 7/18

(52) U.S. Cl. CPC B60L 53/57; B60L 53/51; B60L 58/18; H02J 7/1423; H02J 7/865; H02K 7/1846

(57) ABSTRACT

A battery charging device is disclosed which extends the range and mileage of an electric vehicle by approximately 500 percent. The battery charging device comprises a two-way battery with fixed generators. The device essentially increases the distance an electric vehicle can travel before needing its battery recharged. Two or four wheel driven generators are connected to a charging and discharging battery and to the motor and systems on an electric vehicle to generate power via wheel rotation.

### CROSS-REFERENCE TO RELATED APPLICATION

The present application is a continuation-in-part patent application of, and claims priority to and the benefit of, U.S. patent application Ser. No. 18/887,062, which was filed on Sep. 17, 2024, and claims priority to, and the benefit of, U.S. Provisional Application No. 63/634,064, which was filed on Apr. 15, 2024, both of which are incorporated herein by reference in their entirety.

### FIELD OF THE INVENTION

The present invention relates generally to the field of battery charging devices. More specifically, the present invention relates to a generator device that extends the range and mileage of an electric vehicle. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in battery charging devices. Generally, electric vehicles are beneficial to the environment, eliminating the need to use fossil fuels for travel. Current drawbacks of electric vehicles are the range it can travel before requiring a recharge and how long it takes to recharge the vehicle. People may travel only short distances with their electric vehicles. Further, potential power outages can cause recharging issues, or if people cannot locate a charging station while on the road, they may not be able to travel.

Increasingly, methods of people and goods transportation are moving away from the use of the internal combustion engine and toward the use of electric motors. This change is due to several factors, including increased fuel costs for internal combustion engines, polluting effects of internal combustion engines, and greater efficiency of electric motors. However, there are still barriers to the widespread use of electric vehicles. For instance, completely electric vehicles are often powered by onboard batteries that must be recharged when exhausted. The recharging time can be quite lengthy lasting anywhere from forty-five minutes to four hours or more.

Accordingly, there is a demand for an improved battery charging device that extends the range and mileage of an electric vehicle. More particularly, there is a demand for a battery charging device that generates power via wheel rotation.

Therefore, there exists a long felt need in the art for a battery charging device that provides users with a generator device that extends the range and mileage of an electric vehicle by approximately 500 percent. There is also a long felt need in the art for a battery charging device that features a two-way battery with fixed generators that generate power via wheel rotation. Further, there is a long felt need in the art for a battery charging device that prevents people from having to constantly stop and charge their electric vehicles after short travel distances. Moreover, there is a long felt need in the art for a device that improves electric vehicle battery efficiency with ease and convenience. Further, there is a long felt need in the art for a battery charging device that increases the distance an electric vehicle can travel before needing its battery recharged. Finally, there is a long felt need in the art for a battery charging device that utilizes two or four wheel driven generators.

The subject matter disclosed and claimed herein, in one embodiment thereof, comprises a battery charging device. The device extends the range and mileage of an electric vehicle by approximately 500 percent. The battery charging device comprises a two-way battery with fixed generators. The device essentially increases the distance an electric vehicle can travel before needing its battery recharged. Two or four wheel driven generators are connected to a charging and discharging battery and to the motor and systems on an electric vehicle to generate power via wheel rotation.

In this manner, the battery charging device of the present invention accomplishes all of the forgoing objectives and provides users with a device that extends the range and mileage of an electric vehicle. The device is a two-way battery with fixed generators that generate power via wheel rotation. The device utilizes two or four wheel driven generators.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a battery charging device. The device extends the range and mileage of an electric vehicle by approximately 500 percent. The battery charging device comprises a battery with fixed generators. The device essentially increases the distance an electric vehicle can travel before needing its battery recharged. Wheel driven generators are connected to a charging and discharging battery and to the motor and systems on an electric vehicle to generate power via wheel rotation.

Generally, for the most part, details regarding basic automotive engineering, electrical generators, magnets, electromagnets, coils, stators, rotators, batteries, and the like have been omitted inasmuch as such details are not considered necessary to obtain a complete understanding of the present invention, and are considered to be within the skills of persons of ordinary skill in the relevant art.

In one embodiment, the battery charging device utilizes wheel driven generators to charge a battery of an electric vehicle. The wheel driven generators are dynamic and generate power via wheel rotation of the electric vehicle. Specifically, the wheel driven generators operate by the motion of a vehicle. The generators operate as a typical generator and comprise an input wheel or gear or other suitable component, along with other standard components needed for a generator's operations. The generators are positioned at the top of a vehicle's wheels and at an interior of the wheel, such that the input wheel of the generator contacts the vehicle's wheel. Thus, the input wheel of the generator is rotated by the vehicle wheel, such that as the vehicle wheel rotates, the input wheel spins, which creates power/charge, which is then transmitted to the battery.

In one embodiment, the wheel driven generators can be secured to two of the four vehicle wheels to provide power to the battery. The wheel driven generators would be in communication with the battery to charge it. Typically, an electrical conduit would transfer the power from the generators to the battery, to charge it for use.

In another embodiment, the wheel driven generators can be secured to all four vehicle wheels to provide additional power to the battery. When the generators are secured to all four wheels, they are positioned on an interior wheel, near the top of each wheel.

In one embodiment, the wheel driven generators then transfer power to the battery for powering the vehicle. The battery can be a single battery system which is charged by the generators as it is in use. In operation, when the electric vehicle moves, the wheels rotate. This rotation causes the input wheel of the generators to spin, generating power. This charge/power transmits from the generators through a conduit and to the battery, thus recharging the battery. In this manner, an electric vehicle is constantly under recharge during the operation of the vehicle. Thus, the generation of electricity from the generators result in a decrease in the rate of drain on the electric vehicle's battery, thereby increasing the electric vehicle's range, and decreasing the amount of recharge time needed between electric vehicle uses.

In another embodiment, the battery is a double battery system. In this system, a first battery is charged by the generators, while the second battery is being used to power the electric vehicle. Then, once the second battery is depleted, an electronic switch allows the generators to charge the second battery, while the first battery is being used to power the electric vehicle. The first and second batteries are then switched between, as needed, such that when one battery is being charged, the other battery is being depleted/used.

In another embodiment, the power from the battery is then transferred to the vehicle's motor to drive/power the vehicle. Typically, charge comes into the battery from one side and leaves the battery from the other side. Charge from the battery is then sent via an electrical conduit to the electric motor to power the vehicle.

It may be appreciated that the generation of electricity from the generators result in a decrease in the rate of drain on the electric vehicle's battery, thereby increasing the electric vehicle's range, and decreasing the amount of recharge time needed between electric vehicle uses. Thus, a U.S. consumer is freed from the problems associated with fossil fuels without being subjected to the traditionally long charge times, short ranges, and expensive home infrastructure usually associated with electric vehicles.

In yet another embodiment, the battery charging device comprises a plurality of indicia.

In yet another embodiment, a method of charging an electric vehicle via wheel rotation is disclosed. The method includes the steps of providing a battery charging device comprising a two-way battery with fixed generators. The method also comprises securing the fixed generators to a vehicle wheel. Further, the method comprises generating power via rotation of the wheels. The method also comprises powering a battery from the power from the generators. Finally, the method comprises transferring power to the motor to power the vehicle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A, 1B, 1C, 1D, and 1E illustrate a perspective view of one embodiment of the battery charging device of the present invention showing the device applied to an electric vehicle in accordance with the disclosed architecture;

FIG. 2 illustrates a perspective view of one embodiment of the battery charging device of the present invention showing a single battery system in accordance with the disclosed architecture;

FIG. 3 illustrates a perspective view of one embodiment of the battery charging device of the present invention showing a double battery system in accordance with the disclosed architecture;

FIGS. 4A and 4B illustrate a perspective view of one embodiment of the battery charging device of the present invention showing the generators on a wheel in accordance with the disclosed architecture;

FIG. 5 illustrates a perspective view of one embodiment of the battery charging device of the present invention showing the battery of the device in accordance with the disclosed architecture;

FIG. 6 illustrates a flowchart showing the method of charging an electric vehicle via wheel rotation in accordance with the disclosed architecture; and

FIG. 7 illustrate a perspective view of one embodiment of the battery charging device of the present invention showing the device applied to an electric vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a battery charging device that provides users with a generator device that extends the range and mileage of an electric vehicle by approximately 500 percent. There is also a long felt need in the art for a battery charging device that features a two-way battery with fixed generators that generate power via wheel rotation. Further, there is a long felt need in the art for a battery charging device that prevents people from having to constantly stop and charge their electric vehicles after short travel distances. Moreover, there is a long felt need in the art for a device that improves electric vehicle battery efficiency with ease and convenience. Further, there is a long felt need in the art for a battery charging device that increases the distance an electric vehicle can travel before needing its battery recharged. Finally, there is a long felt need in the art for a battery charging device that utilizes two or four wheel driven generators.

The present invention, in one exemplary embodiment, is a novel battery charging device. The device extends the range and mileage of an electric vehicle by approximately 500 percent. The battery charging device comprises a two-way battery with fixed generators. The device essentially increases the distance an electric vehicle can travel before needing its battery recharged. Two or four wheel driven generators are connected to a charging and discharging battery and to the motor and systems on an electric vehicle to generate power via wheel rotation. The present invention also includes a novel method of charging an electric vehicle via wheel rotation. The method includes the steps of providing a battery charging device comprising a two-way battery with fixed generators. The method also comprises securing the fixed generators to a vehicle wheel. Further, the method comprises generating power via rotation of the wheels. The method also comprises powering a battery from the power from the generators. Finally, the method comprises transferring power to the motor to power the vehicle.

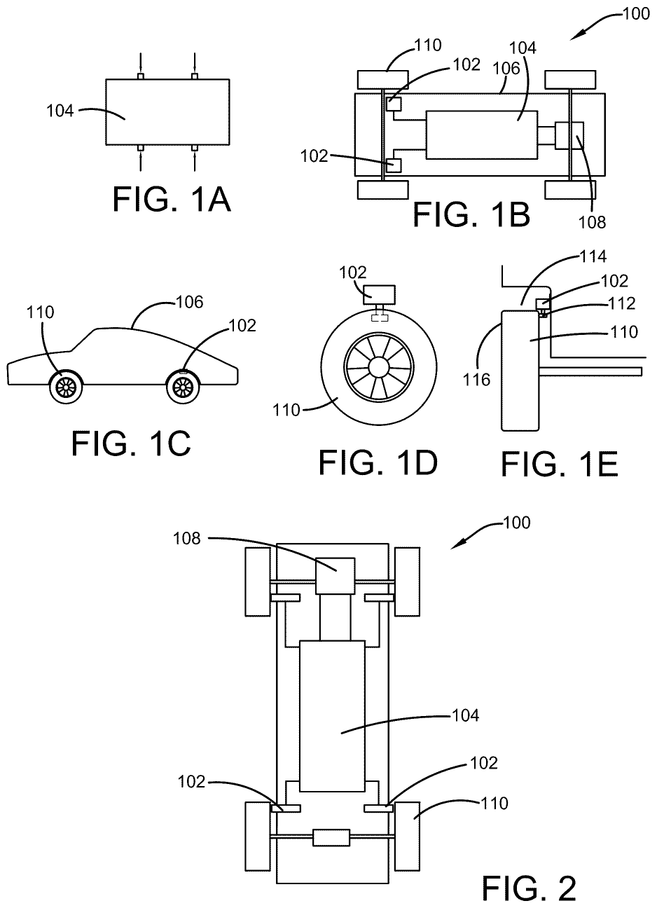

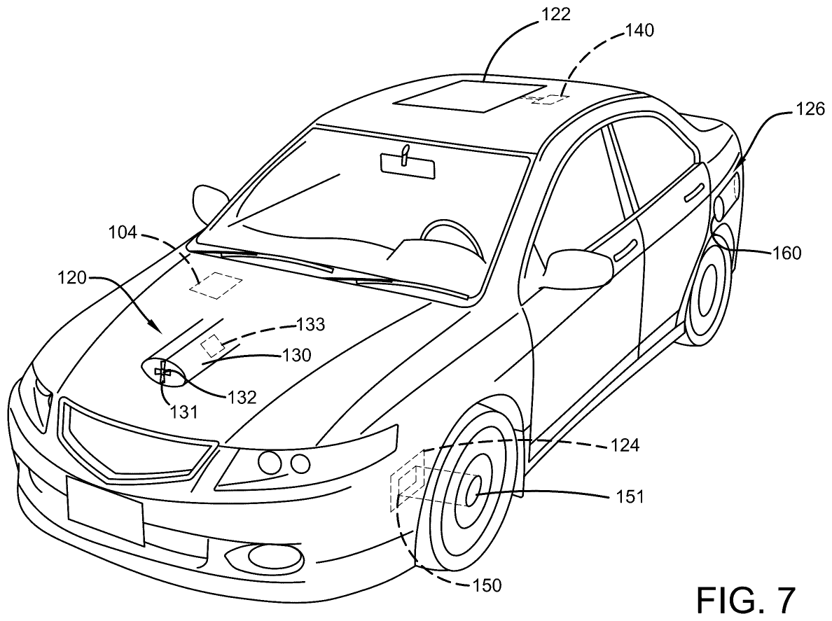

Referring initially to the drawings, FIGS. 1A-E illustrate a perspective view of one embodiment of the battery charging device 100 of the present invention. In the present embodiment, the battery charging device 100 is an improved battery charging device 100 that provides a user with a generator that extends the range and mileage of an electric vehicle. Specifically, the battery charging device 100 comprises a battery 104 with fixed generators 102. The device 100 essentially increases the distance an electric vehicle 106 can travel before needing its battery 104 recharged. Wheel driven generators 102 are connected to a charging and discharging battery 104 and to the motor 108 and systems on an electric vehicle 106 to generate power via wheel 110 rotation. The battery charging device 100 may further comprise at least one rotary scoop turbine 120 (as seen in FIG. 7) that is preferably positioned on the hood of the vehicle, but may be positioned anywhere on the vehicle (such as but not limited to on the sides of the vehicle) to generate energy. The rotary scoop turbine 120 may be comprised of a cylindrical or domed housing 130 with a plurality of blades 131 radially arranged around a central rotor 132. As the vehicle moves forward, incoming air is funneled into the scoops 131, imparting torque to the rotor 132 and thereby generating rotational mechanical energy. This energy is then converted into electrical energy by a turbine generator 133 positioned within or adjacent to the turbine housing. The rotary scoop turbine 120 may be electrically coupled to the battery 104 to supply supplemental charge during vehicle operation.

Generally, for the most part, details regarding basic automotive engineering, electrical generators, magnets, electromagnets, coils, stators, rotators, batteries, and the like have been omitted inasmuch as such details are not considered necessary to obtain a complete understanding of the present invention, and are considered to be within the skills of persons of ordinary skill in the relevant art.

Further, the battery charging device 100 utilizes wheel driven generators 102 to charge a battery 104 of an electric vehicle 106. The wheel driven generators 102 are dynamic and generate power via wheel rotation of the electric vehicle 106. Specifically, the wheel driven generators 102 operate by the motion of a vehicle 106. The generators 102 operate as a typical generator and comprise an input wheel 112 or gear or other suitable component, along with other standard components needed for a generator's operations. The generators 102 are positioned at the top 114 of a vehicle's wheels 110 and at an interior 116 of the wheel 110, such that the input wheel 112 of the generator 102 contacts the vehicle's wheel 110. Thus, the input wheel 112 of the generator 102 is rotated by the vehicle wheel 110, such that as the vehicle wheel 110 rotates, the input wheel 112 spins, which creates power/charge, which is then transmitted to the battery 104. The battery charging device 100 may further comprise at least one solar panel 122 mounted anywhere on the vehicle (such as but not limited to the roof, the trunk, the sides, etc.) to generate energy from sunlight, as seen in FIG. 7. Each solar panel 122 may be comprised of photovoltaic cells laminated in a weather-resistant encapsulation and mounted flush or semi-flush to an exterior surface of the vehicle, such as but not limited to the roof, hood, trunk, or rear window. The photovoltaic cells may be electrically connected to a charge controller 140 that manages the power delivery to the battery 104, enabling solar charging when the vehicle is stationary or in motion.

As shown in FIG. 2, the wheel driven generators 102 then transfer power to the battery 104 for powering the vehicle 106. The battery 104 can be a single battery system which is charged by the generators 102 as it is in use. In operation, when the electric vehicle 106 moves, the wheels 110 rotate. This rotation causes the input wheel 112 of the generators 102 to spin, generating power. This charge/power transmits from the generators 102 through a conduit and to the battery 104, thus recharging the battery 104. In this manner, an electric vehicle 106 is constantly under recharge during the operation of the vehicle 106. Thus, the generation of electricity from the generators 102 result in a decrease in the rate of drain on the electric vehicle's battery 104, thereby increasing the electric vehicle's range, and decreasing the amount of recharge time needed between electric vehicle 106 uses. The battery charging device 100 may also comprise at least one dynamo 124 mounted on or adjacent to the tires to generate energy from tire motion, as seen in FIG. 7. Each dynamo 124 may be comprised of an electrical generator 150 mechanically interfaced with a rotating component 151 of the vehicle wheel assembly, such as the tire sidewall or axle. The dynamo 124 converts rotational or vibrational motion into electrical energy, which may be routed to directly to the battery 104. The dynamo 124 may operate in parallel with the wheel driven generators 102 to provide auxiliary charging capacity during both low- and high-speed operation.

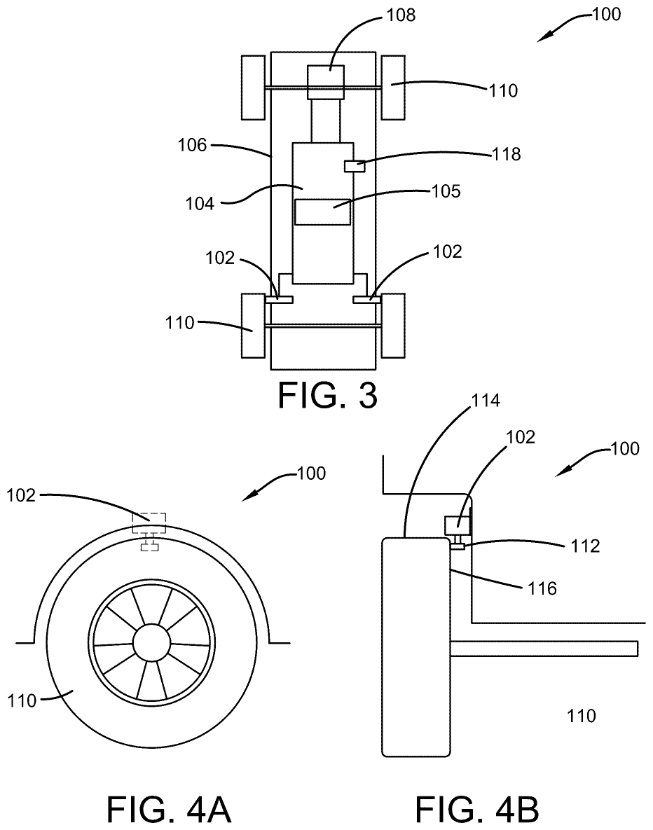

As shown in FIG. 3, the battery 104 is a double battery system. In this system, a first battery 104 is charged by the generators 102, while the second battery 105 is being used to power the electric vehicle 106. Then, once the second battery 105 is depleted, an electronic switch 118 allows the generators 102 to charge the second battery 105, while the first battery 104 is being used to power the electric vehicle 106. The first 104 and second 105 batteries are then switched between, as needed, such that when one battery 104/105 is being charged, the other battery 104/105 is being depleted/used.

As shown in FIGS. 4A-B, the wheel driven generators 102 can be secured to two of the four vehicle wheels 110 to provide power to the battery 104. The wheel driven generators 102 would be in communication with the battery 104 to charge it. Typically, an electrical conduit would transfer the power from the generators 102 to the battery 104, to charge it for use.

In another embodiment, the wheel driven generators 102 can be secured to all four vehicle wheels 110 to provide additional power to the battery 104. When the generators 102 are secured to all four wheels 110, they are positioned on an interior 116 wheel, near the top 114 of each wheel 110.

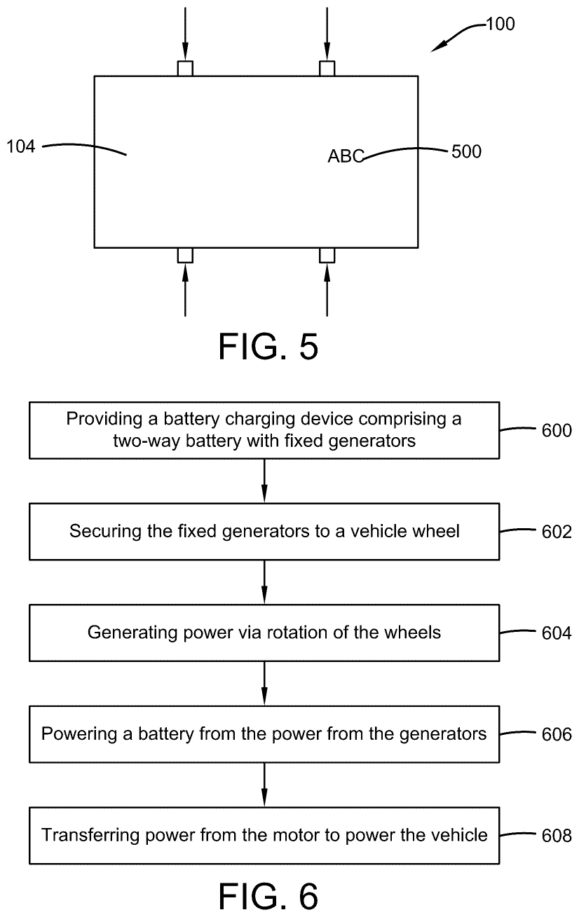

As shown in FIG. 5, the power from the battery 104 is then transferred to the vehicle's motor 108 to drive/power the vehicle 106. Typically, charge comes into the battery 104 from one side and leaves the battery 104 from the other side. Charge from the battery 104 is then sent via an electrical conduit to the electric motor 108 to power the vehicle 106. In addition, the battery charging device 100 may further comprise at least one scoop 126 (as seen in FIG. 7) positioned on the vehicle to reduce drag and improve aerodynamic efficiency. Each scoop 126 may be comprised of a contoured intake element that may be integrated into the body of the vehicle, such as but not limited to on the hood, fenders, or side panels. The scoop 126 may include an internal channel 160 that guides airflow to through the scoop 126, thereby reducing drag on the vehicle.

In yet another embodiment, the battery charging device 100 comprises a plurality of indicia 500. The generator 102 of the device 100 may include advertising, a trademark, or other letters, designs, or characters, printed, painted, stamped, or integrated into the generator 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be generator, electric vehicle, or brand related.

It may be appreciated that the generation of electricity from the generators 102 result in a decrease in the rate of drain on the electric vehicle's battery 104, thereby increasing the electric vehicle's range, and decreasing the amount of recharge time needed between electric vehicle 106 uses. Thus, a U.S. consumer is freed from the problems associated with fossil fuels without being subjected to the traditionally long charge times, short ranges, and expensive home infrastructure usually associated with electric vehicles 106.

FIG. 6 illustrates a flowchart of the method of charging an electric vehicle via wheel rotation. The method includes the steps of at 600, providing a battery charging device comprising a two-way battery with fixed generators. The method also comprises at 602, securing the fixed generators to a vehicle wheel. Further, the method comprises at 604, generating power via rotation of the wheels. The method also comprises at 606, powering a battery from the power from the generators. Finally, the method comprises at 608, transferring power to the motor to power the vehicle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “battery charging device”, “charging device”, and “device” are interchangeable and refer to the battery charging device 100 of the present invention.

Notwithstanding the forgoing, the battery charging device 100 of the present invention can be of any suitable size and configuration as is known in the art without affecting the overall concept of the invention, provided that it accomplishes the above stated objectives. One of ordinary skill in the art will appreciate that the battery charging device 100 as shown in FIGS. 1-6 is for illustrative purposes only, and that many other sizes and shapes of the battery charging device 100 are well within the scope of the present disclosure. Although the dimensions of the battery charging device 100 are important design parameters for user convenience, the battery charging device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery charging device that provides a user with a generator that extends the range and mileage of an electric vehicle, the battery charging device comprising:
a wheel driven generator;
a battery;
a solar panel;
a dynamo;
a rotary turbine;
and
an electric motor;
wherein the wheel driven generators generate power via wheel rotation of an electric vehicle;
wherein the wheel driven generators are connected to the battery to charge the battery;
wherein the battery is in communication with the electric motor to power the electric motor; and
further wherein the electric motor powers the electric vehicle.

2. The battery charging device of claim 1, wherein the wheel driven generator operates as a conventional generator and comprise an input wheel, along with other standard components needed for a generator's operations.

3. The battery charging device of claim 2, wherein the wheel driven generator is positioned at a top of a vehicle's wheel and at an interior of the vehicle's wheel, such that the input wheel of the wheel driven generator contacts the vehicle's wheel during use.

4. The battery charging device of claim 3, wherein the input wheel of the wheel driven generator is rotated by the vehicle's wheel, such that as the vehicle's wheel rotates, the input wheel spins, which creates electrical current which is then transmitted to the battery.

5. The battery charging device of claim 4, wherein the wheel driven generator is secured to two of four vehicle wheels to provide power to the battery.

6. The battery charging device of claim 4, wherein the wheel driven generator is secured to all four vehicle wheels to provide power to the battery.

7. The battery charging device of claim 4, wherein the battery is a single battery system which is charged by the wheel driven generator as it is in use.

8. The battery charging device of claim 4, wherein the battery is a double battery system which includes a first battery and a second battery.

9. The battery charging device of claim 8, wherein the first battery is charged by the wheel driven generator, while the second battery is being used to power the electric vehicle.

10. The battery charging device of claim 9, wherein once the second battery is depleted, an electronic switch allows the wheel driven generator to charge the second battery, while the first battery is being used to power the electric vehicle.

11. The battery charging device of claim 10, wherein the first and the second batteries are then switched between, as needed, such that when one battery is being charged, other battery is being depleted.

12. The battery charging device of claim 11, wherein power from the battery is then transferred to the electric motor to power the electric vehicle.

13. The battery charging device of claim 12 further comprising a plurality of indicia.

14. A battery charging device that provides a user with a generator that extends the range and mileage of an electric vehicle, the battery charging device comprising:
a wheel driven generator comprising an input wheel, along with other standard components needed for a generator's operations;
a battery;
a rotary turbine;
a solar panel;
a dynamo; and
an electric motor;
wherein the wheel driven generator is positioned at a top of a vehicle's wheel and at an interior of the vehicle's wheel, such that the input wheel of the wheel driven generator contacts the vehicle's wheel during use;
wherein the input wheel of the wheel driven generator is rotated by the vehicle's wheel, such that as the vehicle's wheel rotates, the input wheel spins, which creates electrical current which is then transmitted to the battery;
wherein the wheel driven generators are connected to the battery to charge the battery;
wherein the battery is a single battery system which is charged by the wheel driven generator as it is in use;
wherein the battery is in communication with the electric motor to power the electric motor; and
further wherein the electric motor powers the electric vehicle.

15. The battery charging device of claim 14, wherein the wheel driven generator is secured to two of four vehicle wheels to provide power to the battery.

16. The battery charging device of claim 14, wherein the wheel driven generator is secured to all four vehicle wheels to provide power to the battery.

17. The battery charging device of claim 14, wherein the battery is a double battery system which includes a first battery and a second battery.

18. The battery charging device of claim 17, wherein the first battery is charged by the wheel driven generator, while the second battery is being used to power the electric vehicle.

19. The battery charging device of claim 18, wherein once the second battery is depleted, an electronic switch allows the wheel driven generator to charge the second battery, while the first battery is being used to power the electric vehicle.

20. A method of charging an electric vehicle via wheel rotation, the method comprising the following steps:
providing a battery charging device comprising a two-way battery with fixed generators;
securing the fixed generators to a vehicle wheel;
generating power via rotation of the wheels;
powering a battery from the power from the generators; and
transferring power to the motor to power the vehicle.
